(19) United States
(12) Patent Application Publication
(10) Pub. No.: US 2016/0072918 A1
(43) Pub. Date: Mar. 10, 2016

(54) System and Method for Acquisition, Management and Distribution of User-Generated Digital Media Content

(71) Applicant: Ashot Gabrelyanov, Brooklyn, NY (US)

(72) Inventor: Ashot Gabrelyanov, Brooklyn, NY (US)

(21) Appl. No.: 14/848,826

(22) Filed: Sep. 9, 2015

Related U.S. Application Data
(60) Provisional application No. 62/047,985, filed on Sep. 9, 2014.

(51) Int. Cl. H04L 29/08; H04W 4/02

(52) U.S. Cl. CPC H04L 67/322; H04W 4/02; H04L 67/18; H04L 67/327

(57) ABSTRACT

Disclosed are systems and methods for acquisition, management and distribution of digital media content. An exemplary system includes a content management server that generates a content request task comprising a plurality of parameters, including a content description and a location for content acquisition; identifies one or more registered and active mobile device users that match one or more parameters of the content request task; transmits the content request task to one or more identified mobile device users that match one or more parameters of the content request task; receives the requested digital media content from one or more mobile device users; processes the received digital media content for previewing, editing and moderating the content by a content moderator; determines, based on results of the moderation, whether to accept or reject the digital media content received from user; and submits accepted digital media content to one or more media distribution platforms.

### CROSS-REFERENCE TO RELATED APPLICATIONS

This application claims benefit of priority of Provisional Application No. 62/047,985 filed Sep. 9, 2014, which is incorporated herein by reference in its entirety.

### TECHNICAL FIELD

The present disclosure is directed to the field of digital media, and more specifically, to systems and methods for acquisition, management and distribution of user-generated digital media content.

### BACKGROUND

The growth in popularity of personal communication devices, such as mobile phones, and tablets, has resulted in a tremendous increase in the volume of user-generated digital media content, such as videos, photos and audio recordings. Any user of a mobile device, that has a built-in video camera and microphone, can capture high-resolution video and audio and instantaneously distribute it over a cellular or Wi-Fi network to other people via email and text messages, post it to social networking websites, such as Facebook®, photo-sharing websites, such as Instagram®, and video-sharing websites, such as YouTube®. However, most of these websites provide limited distribution of the user-generated content, which results in a large volume of videos and photos that is made available to limited audiences of online visitors of these website, such as friends and followers of the users who generated this content. The current technologies do not allow mobile device users to distribute user-generated digital media content to broadcast television stations and cable networks for “on-air” distribution.

### SUMMARY

Disclosed are systems, methods and computer program products for acquisition, management and distribution of user-generated digital media content. In one exemplary aspect, a system includes a content management server configured to: generate a content request task comprising a plurality of parameters, including a content description and a location for content acquisition; identify one or more registered and active mobile device users that match one or more parameters of the content request task; transmit the content request task to one or more identified mobile device users that match one or more parameters of the content request task; receive the requested digital media content from one or more mobile device users; process the received digital media content for previewing, editing and moderating the content by a content moderator; determine, based on results of the moderation, whether to accept or reject the digital media content received from user; and submit accepted digital media content to one or more media distribution platforms.

In one exemplary aspect, digital media content includes one or more of a video recording, a photo, an audio recording and a life streaming video.

In one exemplary aspect, the content request task further includes additional parameters including one or more of: a deadline for submission of the content to the content management server by a user; a designation of a group of users to whom a content request task to be send; and a payment amount for submission of the requested digital media content.

In one exemplary aspect, the system further configured to make an electronic payment to a user whose content was accepted by the content management server.

In one exemplary aspect, a registered and active mobile device user is a user who created a user account on the content management server and launched a content management application on its mobile device.

In one exemplary aspect, indentifying one or more registered and active mobile device users that match one or more parameters of the content request task includes: displaying a geographic map showing locations of one or more registered and active mobile device user.

In one exemplary aspect, identifying one or more registered and active mobile device users that match one or more parameters of the content request task includes: selecting one or more mobile devices users whose geographic location matches the location for content acquisition parameter of the content request task.

In one exemplary aspect, indentifying one or more registered and active mobile device users that match one or more parameters of the content request task comprises: for each identified mobile device user displaying one or more of: a personal information of the user, rating of the user, statistics of submitted content by the user, a list of submitted content, information about mobile device of the user, and payment history of the user.

In one exemplary aspect, receiving a video recording from a mobile device user includes: determining a speed of network connection with the mobile device user using a content management application launched on the mobile device of the user; and when the speed of the network connection is below a threshold, requesting the content management application to transmit to the content management server one or more key frames of the video recording that have the most content changes therein.

In one exemplary aspect, receiving a digital media content from one or more mobile device users includes: determining a speed of network connection with one of the identified mobile device user using a content management application launched on the mobile device of the user; and when the speed of the network connection is below a threshold, requesting one or more other identified mobile device users to acquire the requested content and distributing transmission of the acquired digital media content among two or more mobile device users.

In one exemplary aspect, processing the received digital media content includes: generating, by the content management server, a graphical user interface (GUI) for display to the content moderator, the GUI comprising a grid of previews of the digital media contents received from the users, wherein a preview of a video recording includes auto-playing a plurality of preselected video frames of the video recording, in the displayed GUI grid.

In one exemplary aspect, the media distribution platform includes one of a television station, a radio station, a cable network, a social networking website, a photo-sharing website, a video-sharing website, an online store, and an online auction.

In another exemplary aspect, a method for management of digital media content comprises: generating, by a content management server, a content request task comprising a plurality of parameters, including a content description and a location for content acquisition; identifying, by the content management server, one or more registered and active mobile device users that match one or more parameters of the content request task; transmitting the content request task to one or more identified mobile device users that match one or more parameters of the content request task; receiving the requested digital media content from one or more mobile device users; processing, by the content management server, the received digital media content for previewing, editing and moderating the digital media content by a content moderator; determining, by the content management server, based on results of the moderation, whether to accept or reject the received digital media content; and submitting accepted digital media content to one or more media distribution platforms.

In yet another exemplary aspect, A non-transitory computer readable medium storing computer executable instructions for management of digital media content, including instructions for: generating a content request task comprising a plurality of parameters, including a content description and a location for content acquisition; identifying one or more registered and active mobile device users that match one or more parameters of the content request task; transmitting the content request task to one or more identified mobile device users that match one or more parameters of the content request task; receiving the requested digital media content from one or more mobile device users; processing the received digital media content for previewing, editing and moderating the content by a content moderator; determining based on results of the moderation, whether to accept or reject the digital media content received from user; and submitting accepted digital media content to one or more media distribution platforms.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF DRAWINGS

The accompanying drawings, which are incorporated into and constitute a part of this specification, illustrate one or more example aspects of the present disclosure and, together with the detailed description, serve to explain their principles and implementations.

FIG. 1 illustrates a block diagram of an exemplary system for acquisition, management and distribution of user-generated digital media content.

FIG. 2 illustrates a block diagram of an exemplary content management server of the system for acquisition, management and distribution of user-generated digital media content.

FIG. 3 illustrates a flow diagram for an exemplary method of operation of the content management server of the system for acquisition, management and distribution of user-generated digital media content.

FIG. 4 illustrates a flow diagram for an exemplary method of operation of the content management application of the system for acquisition, management and distribution of user-generated digital media content.

FIG. 5 illustrates an example of a general-purpose computer system on which the disclosed systems and methods can be implemented.

### DETAILED DESCRIPTION

Example aspects are described herein in the context of a system, method and computer program product for acquisition, management and distribution of user-generated digital media content. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

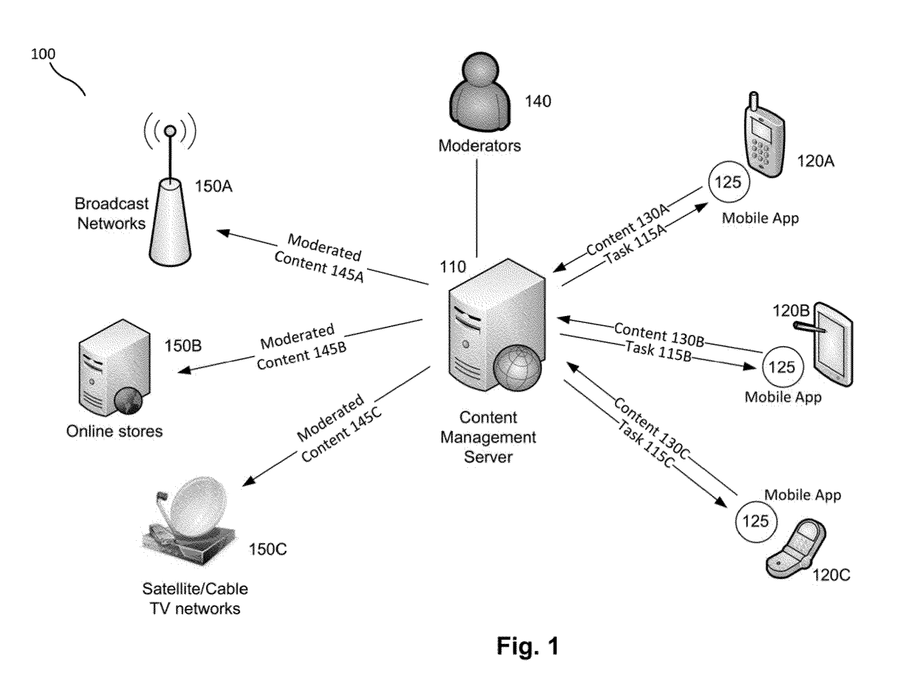

FIG. 1 illustrates a block diagram of an exemplary system for acquisition, management and distribution of user-generated digital media content. In one exemplary aspect, the system 100 includes a content management server 110 that facilitates acquisition, management and on-air and online distribution of user-generated digital media content 130. Although only one server 110 is depicted, it should be appreciate that functionality of the content management server 110 may be distributed between several physical or virtual computers. The content 130 includes, but not limited to video recordings, photos, audio recordings and streaming video, generated by mobile device users 120. The content 130 may be acquired from various mobile devices users 120 who are registered with the content management server 110. The mobile devices include, but not limited to smart phones, tablets, wireless digital camcorders, or other computing devices having wireless communication capabilities, such as cellular, Wi-Fi or Bluetooth network interface cards, as well as built-in digital video cameras and microphones.

In one exemplary aspect, the content management server 110 communicates with each mobile device user 120 via a content management application 125 (also referred herein as “mobile app”). The mobile device user 120 may download a mobile app 125 for free directly from the content management server 110 or from an app store, such as Google® Play, Apple® iTunes® and Amazon® App Store. Generally, the mobile app 125 allows users to register (i.e., create a user account) with the server 110, provide mobile device location information to the server 110, receive content request tasks 115 from the server 110, submit user-generated digital media content 130 to the server 110, manage users' digital media content 130 stored on the server 110, and perform other functions which will be described in greater detail herein below. In another aspect, the functionality of the content management application 125 may be implemented in a website hosted by a web server (not shown) associated with the content management server 110, which can be accessed by the mobile device user 120 via the internet.

In another exemplary aspect, the content management server 110 is configured to generate content request tasks 115 and transmit these tasks to one or more selected mobile device users 120. The content management server 110 generates content request tasks 115 based on a plurality of different parameters specified by human moderators 140 using task templates provided by the content management server 110. Generally, a content request task 115 may include the following parameters: a description of the content that needs to be acquired by the user, a geographic location where content can be acquired, a deadline by which the content must be submitted to the server 110, a payment amount for the submission of the content, and other parameters which will be described in greater detail herein below.

In yet another exemplary aspect, the content management server 110 is configured to process content 130 received from mobile device users 120 for purpose of previewing, editing and moderating the content 130 by content moderators 140. The processes of previewing, editing and moderating content 130 will be described in greater detail herein below. If, as a result of these three processes, the content 130 is accepted by the moderator 140, the content management server 110 is configured to distribute the moderated content 145 to various media distribution platforms 150, including, but not limited to broadcast networks 150A (e.g., television broadcast stations, radio broadcast stations, etc.), cable or satellite networks 150C, and online platforms 150C (e.g., online stores, online auctions, social networking websites, photo-sharing websites, video-sharing websites, etc.). As such, the user-generated content 130 will be published on the air and/or online via several different media distribution platforms 150, which provide large and diverse viewing audiences for the user-generated content 130.

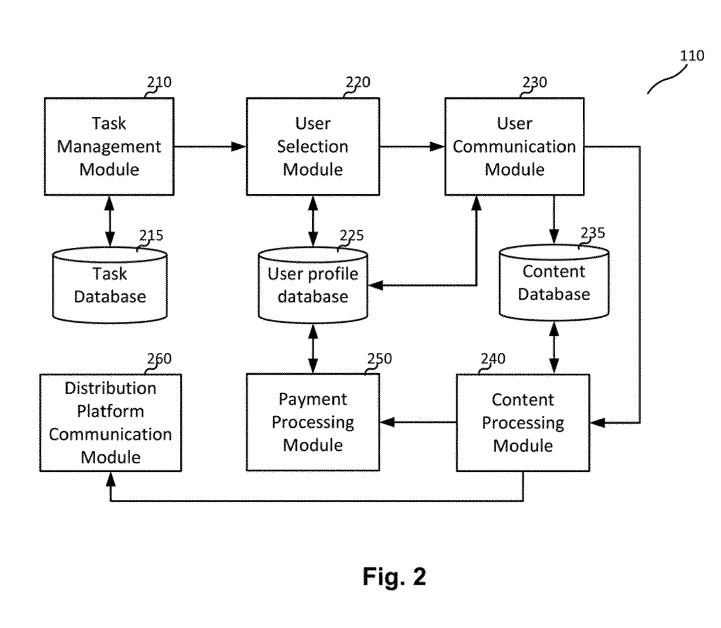

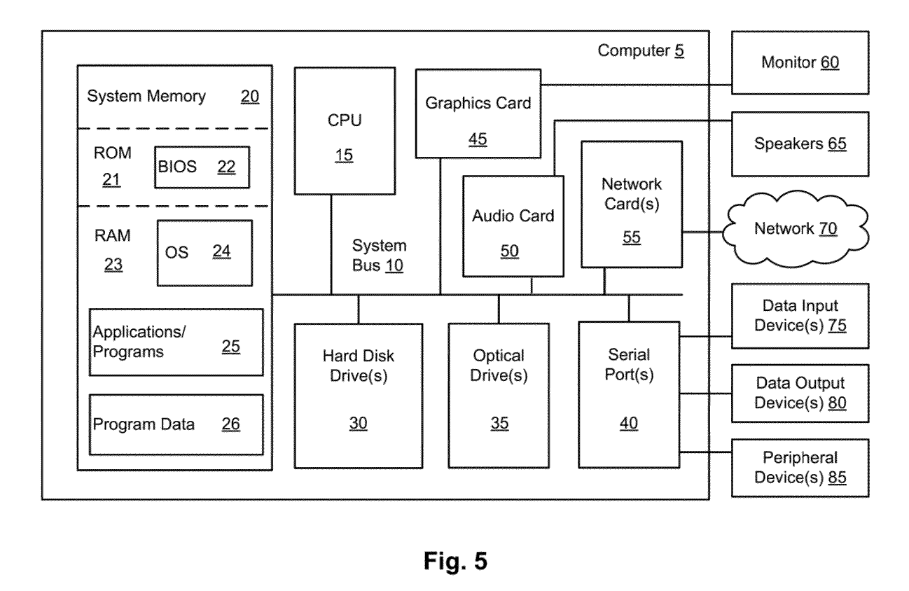

FIG. 2 illustrates a configuration of an exemplary content management server 110 of the system for acquisition, management and distribution of user-generated digital media content. As shown, the server 110 includes, but not limited to a task management module 210, a task database 215, a user selection module 220, a user profile database 225, a user communication module 230, a content database 235, a content processing module 240, a payment processing module 250, and a distribution platform communication module 260. The term “module” as used herein refers to a real-world device, component, or arrangement of components implemented using, for example, a combination of hardware and software, such as by a microprocessor system and a set of instructions to implement the module's functionality, which (while being executed) transform the microprocessor system into a special-purpose device. In certain implementations, at least a portion, and in some cases, all, of a module can be executed on the processor of a general-purpose computer (such as the one described in greater detail in FIG. 5 below). Accordingly, each module can be realized in a variety of suitable configurations, and should not be limited to any particular implementation exemplified herein.

In one exemplary aspect, the task management module 210 of the content management server 110 enables moderators 140 to create new content request tasks 115, manage existing tasks 115 (e.g., change status, change parameters, etc.), delete old/outdated tasks 115, and perform other task management functions. When a moderator 140 wants to create a new content request task, the task management module 210 provides a task template that includes a plurality of fields allowing the moderator 140 to specify various parameters of the new tasks. In one exemplary aspect, a content request task 115 may include the following parameters: a unique task identifier, a status of the task (e.g., opened, closed, paused), a short name of the task (e.g., building fire in Manhattan), a brief description of the content that needs to be acquired by the user (e.g., a video or photos of the fire in a residential building in Midtown Manhattan), a geographic location where content can be acquired (e.g., country, city, street address, zip code, or street intersection), a deadline by which the content must be submitted to the server 110 (e.g., within 2 hours of receipt of the content request task), and a remuneration (i.e., payment amount) for the submission of the content (e.g., $100). Later, the content management module 110 may automatically add to the content request task 115 additional parameters, including, but not limited to identifiers of users 120 who submitted content in response to the task 115, identifiers of user-generated content 130 submitted in response to the task 115, and other parameters. The task management module 210 may store created content request tasks 115 in the task database 215. The tasks 115 stored in the database 215 may be searched using values of their various parameters.

In one exemplary aspect, the user selection module 220 is configured to select one or more registered and active mobile device users 120 to whom that task should be transmitted. A registered and active mobile device user s a user who created a user account on the content management server 110 and launched a mobile app 125 on its mobile device. in one aspect, the user selection module 220 selects users that match one or more parameters of a newly created content request task 115. For example, the user selection module 220 may select one or more mobile devices users 120 whose geographic location matches (e.g., within 10 miles radius) the location parameter of the content request task 115. To that end, the user selection module 220 may determine current locations of the active the active mobile devices users 120 (e.g., their GPS or GLONASS coordinates) and compare them to the location parameter (e.g., GPS or GLONASS coordinates) of the content request task 115. The information about location of the mobile devices (e.g., its GPS or GLONASS coordinates) may be periodically (e.g., every 5 minutes) transmitted to the server 110 by mobile apps 125 running on those mobile devices.

In another aspect, the user selection nodule 220 may generate and display to the moderator 140 an interactive geographic map that may be centered around the location parameter of the content request task 115 and also showing locations of registered and active mobile device user 120 located within a radius selected by the moderator (e.g., within 10 miles radius). For example, the map function may be power by Google Maps or other similar services. The moderator 140 may click designators of active mobile devices displayed on the map to view information about their users 120. All information about users 120 is stored in a user profile database 225 and retrieved by the user selection module 220 for display to the moderator 140. Having reviewed information about available users 120 the moderator 140 may manually select one or more users 120 to whom content request task 115 should be sent. The user selection module 220 may pass identifiers of the selected mobile device users 120 to task management module 210, which will add identifiers of the selected users 120 as parameters of the content request task 115 and update the task database 215 accordingly.

In one exemplary aspect, the user profile database 225 contains information about registered mobile device users 120. A user profiles may include, but not limited to the following information: a unique user identifier, user's email address, user's phone number rent location of the mobile device user, personal information of the user (e.g., name, age, photo, language, etc.), various ratings of the user, statistics about digital media content submitted by the user (e.g., number of accepted content submissions, number of rejected content submissions), a list of submitted content (e.g., list of unique content identifiers), information about mobile device of the user (e.g., make, model, OS type, cellular operator, etc.), billing information (e.g., PayPal account ID), payment history, user group affiliations, and other information. In one exemplary aspect, ratings of a mobile device user 120 may measure the user 120 relative to other registered users, and may include a system generated rating and a moderator specified rating. The system generated rating may be based on the user's activity on the system (e.g., how often and how much content does the user submit) and the quality of the submitted content (e.g., how much content was accepted and how much content was rejected). The moderator specified ratings may be generated by one or more moderators 140 based on their experience with working with this user. Using user ratings, a moderator 140 may select to send a content request task 115 only to users 120 having a certain rating. In another exemplary aspect, user group affiliations may include a listing of groups with which the user is affiliated (e.g., NY stringers group). In this manner, a moderator 140 may select to send a content request task 115 to one or more individual users 120 or to a group of users 120.

In one exemplary aspect, the user communication module 230 enables communication between the content management server 110 and registered mobile user devices 120 via the Internet. Particularly, the user communication module 230 is configured to transmit content request tasks 115 to mobile device users 120 and to receive user-generated digital media content 130 from mobile device users 120. In one exemplary aspect, transmission of content request tasks 115 to mobile device users 120 may be implemented as follows: the user communication module 230 receives a new content request task 115 from the task management module 210, determines selected mobile devices users 120, retrieves from the user profile database 225 network connection information (e.g., IP addresses, MAC addresses, phone number, etc.) of the mobile devices of the selected users 120, establishes network connections with the mobile devices, and transmits content request task 115 to the selected mobile device users 120. in one aspect, the user communication module 230 may use Push technology to transmit content request task 115 to the selected mobile device users 120.

In another exemplary aspect, the user communication module 230 is configured to receive via the Internet user-generated digital media content 130 from mobile apps 125 deployed on mobile devices of users 120. The content 130 may include, but not limited to video recordings, photos, audio recordings and streaming video, generated by mobile device users 120. In one exemplary aspect, the mobile app 125 may transmit content 130 using http protocol and using a symmetric block cipher encryption algorithm AES (Advanced Encryption Standard) with 256-bit key to ensure the safe transfer of data from the mobile app 125 to the content management server 110 from any point in the world. The user communication module 230 stores all received digital media content 130 in a content database 235.

In one exemplary aspect, before receiving content 130 from a mobile device, the user communication module 230 may determine the size of the user-generated content 130 and/or the speed (e.g., bandwidth) of network connection with the mobile device user 120. The information about the size of the content 130 and the speed of network connection may be provided by the mobile app 215. If the size of the content is above a certain threshold (e.g., greater than 500 MB), which may be the case with large, high resolution video files, and/or the speed of the network connection with mobile device user 120 is below a certain threshold (e.g., less than 5 Mbps), then transmission of the content 130 from the mobile device to the content server 110 may take too much time and consume too much processing resources of the mobile device. In this case, the user communication module 230 may instruct the mobile app 125 to transmit to the server 110 one or more key frames of the video file. The key frames may be those frames that have most content changes therein relative to the adjacent frames. The received key frames may be stored in the content database 235. The moderator 140 may then preview the received key frames of the content 130 and, if content appears to be relevant, the moderator 140 may request mobile app 125 to transmit the entire content 130.

In another exemplary aspect, when the user communication module 210 determines that the size of the user-generated content 130 above a certain threshold (e.g., greater than 500 MB) and/or the speed network connection with mobile device user 120 is below a certain threshold (e.g., less than 5 Mbps), the acquisition of the content 130 may be distributed between several collocated mobile device users 120. Particularly, the user communication module 230 may identify via mobile apps 125 one or more other selected mobile device users 120 who acquired the same content in response to the content request task 115. The user communication module 230 may then instructs all identified mobile device to distribute transmission of the acquired digital media content 130 amongst themselves. In this manner, the entire content 130 may be broken into packets, the packets may be distributed between two or more collocated mobile devices using Bluetooth, and transmitted to the content management server 110 by each mobile device separately. At the server 110, the user communication module 230 reassembles the received content packets from several mobile devices and stores the reassembled content 130 into the content database 235. in this man the speed of content acquisition may be significantly increased.

In one exemplary aspect, the content processing module 240 is configured to process the received digital media content 130 for previewing, editing and moderating the content 130 by moderators 140. Particularly, when a moderator 140 logs into the server 110 to check the status of a content request task 115, the content processing module 240 searches for and retrieves from the content database 235 all digital media content 130 submitted by users 120 in response to this task 115. In one exemplary aspect, the content processing module 240 displays a GUI grid of previews of the digital media contents 130 along with information about users who submitted each content item 130. The moderator 140 may preview each displayed content item 130, request full content from the user, edit the received content using standard photo/video editing tools provided by the content management module 240 (e.g., crop or redact photos, cut certain frames from video file, blur certain images, add audio commentary, or text captions, add channel branding, etc.), start an online chat with the user to, for example, request additional content from the user, and perform other functions. The moderator 140 then performs moderation of the content 130, which includes accepting or rejecting the content 130. The status of the moderation may be displayed for each moderated content 130. The user 120 is notified about acceptance or rejection of his content by the moderator 140. When the content is accepted, moderator 140 selects one or more media distribution platforms 150 to which moderated content 145 will be submitted for publication.

In one exemplary aspect, the payment processing module 250 is configured to make electronic payments to a user whose content was accepted by the content management server 110. User's billing information (e.g., PayPal user ID) may be obtained from the user profile database 225. And, payment information associated with the content 130 may be obtained from the associated content request task 115 stored in the task database 215. Once the payment is processed by the module 250, the user may be notified via mobile app 215 that a payment has been made for the accepted user-generated digital media content 130. In this manner, the user 120 is compensated for submission of digital media content 130.

In one exemplary aspect, the distribution platform communication module 260 is configured to communicate with multiple media distribution platforms 150 including, but not limited to broadcast networks 150A (e.g., television broadcast stations, radio broadcast stations, etc.), cable or satellite networks 150C, and online platforms 150C (e.g., online stores, online auctions, social networking websites, photo-sharing websites, video-sharing websites, etc.). In one exemplary aspect, distribution platform communication module 260 may transmit moderated content 145 using http protocol and using a symmetric block cipher encryption algorithm AES (Advanced Encryption Standard) with 256-bit key to ensure the safe transfer of data to various media distribution platforms 150 located anywhere in the world. As a result, the user-generated content 145 will be published on the air and/or online via several different media distribution platforms 150, which provide large and diverse viewing audiences for the user-generated content 145. Once the content is submitted to one or more media distribution platforms 150, the user 120 may be notified via mobile app 215 that his/her digital media content 130 was submitted to one or more media distribution platforms 150.

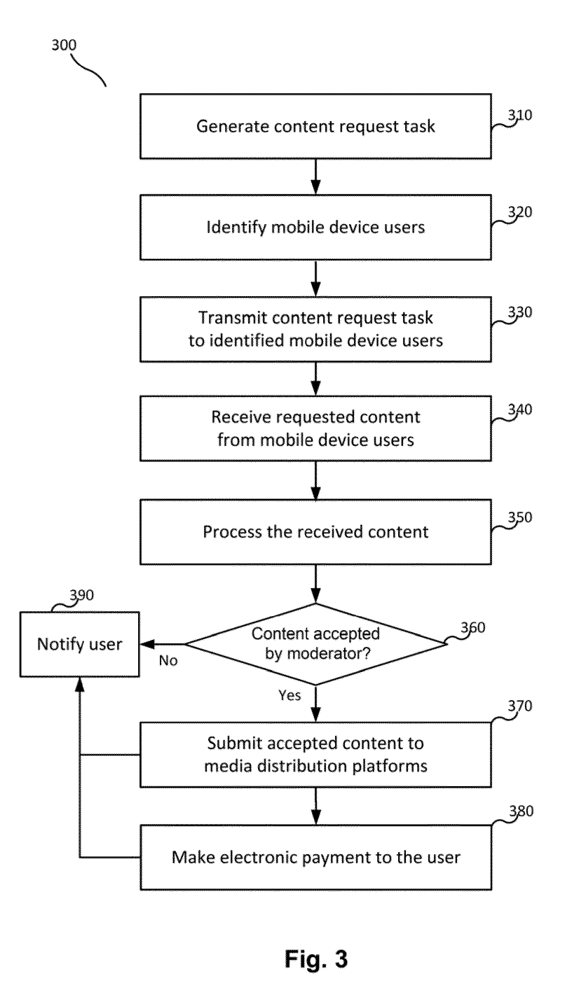

FIG. 3 illustrates a flow diagram for an exemplary method 300 of operation of the content management server of the system for acquisition, management and distribution of user-generated digital media content. According to method 300, in step 310, a content management server 110 generates a content request task 115 comprising a plurality of parameters, including, for example, a content description and a location for content acquisition. In step 320, the content management server 110 identifies one or more registered and active mobile device users 120 that match one or more parameters of the content request task 115. In step 330, the content management server 110 transmits the content request task 115 to one or more identified mobile device users 120 that match one or more parameters of the content request task 115. In step 340, the content management server 110 receives the requested digital media content 130 from one or more mobile device users 120. In step 350, the content management server 110 processes the received digital media content 130 for previewing, editing and moderating the digital media content by a content moderator 130. In step 360, the content management server 110 determines, based on results of the moderation, whether to accept or reject the received digital media content 130. In step 390, the content management server notifies the user 120 if his/her content 130 was rejected by the moderator 140. in step 370, the content management server 110 submits accepted and moderated digital media content 145 to one or more media distribution platforms 150. In step 390, the content management server 110 notifies the user 120 about submission of his/her content 130 to one of more media distribution platforms 150. In step 380, the content management server 110 makes an electronic payment to the user 120 for the submission of the accepted digital media content 130. In step 390, the content management server 110 notifies the user 120 about the payment for the submission of accepted digital media content.

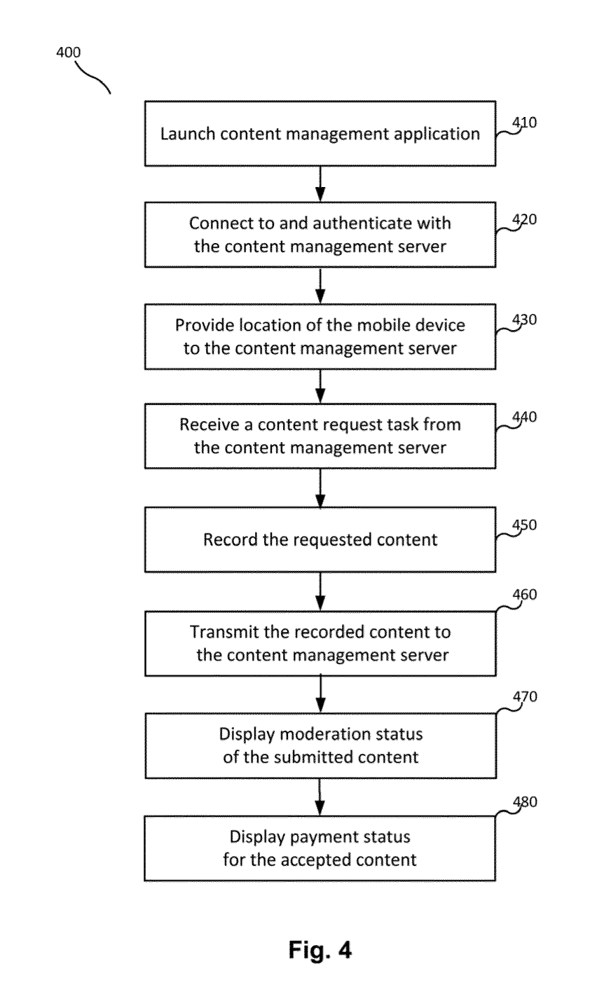

FIG. 4 illustrates a flow diagram for an exemplary method 400 of operation of the content management application of the system for acquisition, management and distribution of user-generated digital media content. According to method 400, in step 410, a content management app 125 is installed and launched on a mobile device 120 by the device user. In step 420, the content management app 125 connects to the content management server and authenticates the user of the mobile device 120. In step 430, the content management app 125 provides location information of the mobile device 120 to the content management server 110. In step 440, the content management app 125 receives a content request task 115 from the content management server 110. In step 450, the user uses content management app 125 to create (record) the requested content 130. In step 460, the content management app 125 transmits the recorded content 130 to the content management server 110. In step 470, the content management app 125 receives a notification from the content management server 110 about content moderation status, and displays this status to the user. In step 480, the content management app 125 receives a notification from the content management server 110 about payment status for the accepted content 130, and displays this status to the user.

FIG. 5 illustrates one example aspect of a computer system 5 that may be used to implement the disclosed systems and methods for acquisition, management and distribution of user-generated digital media content. The computer system 5 may include, but not limited to, a personal computer, a notebook, tablet computer, a smart phone, a mobile device, a network server, a router, or other type of processing device. As shown, computer system 5 may include one or more hardware processors 15, memory 20, one or more hard disk drive(s) 30, optical drive(s) 35, serial port(s) 40, graphics card 45, audio card 50 and network card(s) 55 connected by system bus 10. System bus 10 may be any of several types of bus structures including a memory bus or memory controller, a peripheral bus and a local bus using any of a variety of known bus architectures. Processor 15 may include one or more Intel® Core 2 Quad 2.33 GHz processors or other type of microprocessor.

System memory 20 may include a read-only memory (ROM) 21 and random access memory (RAM) 23. Memory 20 may be implemented as in DRAM (dynamic RAM), EPROM, EEPROM, Flash or other type of memory architecture. ROM 21 stores a basic input/output system 22 (BIOS), containing the basic routines that help to transfer information between the modules of computer system 5, such as during start-up. RAM 23 stores operating system 24 (OS), such as Windows® 7 Professional or other type of operating system, that is responsible for management and coordination of processes and allocation and sharing of hardware resources in computer system 5. Memory 20 also stores applications and programs 25. Memory 20 also stores various runtime data 26 used by programs 25.

Computer system 5 may further include hard disk drive(s) 30, such as SATA HDD, and optical disk drive(s) 35 for reading from or writing to a removable optical disk, such as a CD-ROM, DVD-ROM or other optical media. Drives 30 and 35 and their associated computer-readable media provide non-volatile storage of computer readable instructions, data structures, applications and program modules/subroutines that implement algorithms and methods disclosed herein. Although the exemplary computer system 5 employs magnetic and optical disks, it should be appreciated by those skilled in the art that other types of computer readable media that can store data accessible by a computer system 5, such as magnetic cassettes, flash memory cards, digital video disks, RAMs, ROMs, EPROMs and other types of memory may also be used in alternative aspects of the computer system 5.

Computer system 5 further includes a plurality of serial ports 40, such as Universal Serial Bus (USB), for connecting data input device(s) 75, such as keyboard, mouse, touch pad and other. Serial ports 40 may be also be used to connect data output device(s) 80, such as printer, scanner and other, as well as other peripheral device(s) 85, such as external data storage devices and the like. System 5 may also include graphics card 45, such as nVidia® GeForce® GT 240M or other video card, for interfacing with a display 60 or other video reproduction device, such as touch-screen display. System 5 may also include an audio card 50 for reproducing sound via internal or external speakers 65. In addition, system 5 may include network card(s) 55, such as Ethernet, WiFi, GSM, Bluetooth or other wired, wireless, or cellular network interface for connecting computer system 5 to network 70, such as the Internet.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In various aspects, the systems and methods described in the present disclosure can be addressed in terms of modules. The term “module” as used herein refers to a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module can also be implemented as a combination of the two, with certain functions facilitated by hardware alone, and other functions facilitated by a combination of hardware and software. In certain implementations, at least a portion, and in some cases, all, of a module can be executed on the processor of a general purpose computer (such as the one described in greater detail in FIG. 5 above). Accordingly, each module can be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and tine-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term n the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for management of digital media content, the method comprising:
generating, by a content management server, a content request task comprising a plurality of parameters, including a content description and a location for content acquisition;
identifying, by the content management server, one or more registered and active mobile device users that match one ore parameters of the content request task;
transmitting the content request task to one or more identified mobile device users that match one or more parameters of the content request task;
receiving the requested digital media content from one or more mobile device users;
processing, by the content management server, the received digital media content for previewing, editing and moderating the digital media content by a content moderator
determining, by the content management server, based on results of the moderation, whether to accept or reject the received digital media content; and
submitting accepted digital media content to one or more media distribution platforms.

2. The method of claim 1, wherein digital media content includes or more of a video recording, a photo, an audio recording and a life streaming video.

3. The method of claim 1, wherein the content request task further includes additional parameters including one or more of:
a deadline for submission of the content to the content management server by a user;
a designation of a group of users to whom a content request task to be send; and
a payment amount for submission of the requested digital media content.

4. The method of claim 3, further comprising: making an electronic payment to a user whose content was accepted by the content management server.

5. The method of claim 1, wherein a registered and active mobile device user is a user who created a user account on the content management server and launched a content management application on its mobile device.

6. The method of claim 1, wherein indentifying one or more registered and active mobile device users that match one or more parameters of the content request task includes:
displaying a geographic map showing locations of one or more registered and active mobile device user.

7. The method of claim 1, wherein identifying one or more registered and active mobile device users that match one or more parameters of the content request task includes:
selecting one or more mobile devices users whose geographic location matches the location for content acquisition parameter of the content request task.

8. The method of claim 1, wherein indentifying one or more registered and active mobile device users that match one or more parameters of the content request task comprises: for each identified mobile device user displaying one or more of: a personal information of the user, a rating of the user, statistics of submitted content by the user, a list of submitted content, information about mobile device of the user, and payment history of the user.

9. The method of claim 2, wherein receiving a video recording from a mobile device user includes:
determining a speed of network connection with the mobile device user using a content management application launched on the mobile device of the user; and
when the speed of the network connection is below a threshold, requesting the content management application to transmit to the content management server one or more key frames of the video recording that have the most content changes therein.

10. The method of claim 2, wherein receiving a digital media content from one or more mobile device users includes:
determining a speed of network connection with one of the identified mobile device user using a content management application launched on the mobile device of the user; and
when the speed of the network connection is below a threshold, requesting one or more other identified mobile device users to acquire the requested content and distributing transmission of the acquired digital media content among two or more mobile device users.

11. The method of claim 1, wherein processing the received digital media content includes:
generating, by the content management server, a graphical user interface (GUI) for display to the content moderator, the GUI comprising a grid of previews of the digital media contents received from the users, wherein a preview of a video recording includes auto-playing a plurality of preselected video frames of the video recording in the displayed GUI grid.

12. The method of claim 1, wherein media distribution platform includes one of a television station, a radio station, a cable network, a social networking website, a photo-sharing website, a video-sharing website, an online store, and an online auction.

13. A system for management of digital media content, the system comprising:
a content management server having a hardware processor configured to:
generate a content request task comprising a plurality of parameters, including a content description and a location for content acquisition;
identify one or more registered and active mobile device users that match one or more parameters of the content request task;
transmit the content request task to one or more identified mobile device users that match one or more parameters of the content request task;
receive the requested digital media content from one or more mobile device users;
process the received digital media content for previewing, editing and moderating the content by a content moderator;
determine, based on results of the moderation, whether to accept or reject the digital media content received from user; and
submit accepted digital media content to one or more media distribution platforms.

14. The system of claim 13, wherein digital media content includes one or more of a video recording, a photo, an audio recording and a streaming video.

15. The system of claim 13, wherein the content request task further includes additional parameters including one or more of:
a deadline for submission of the content to the content management server by a user;
a designation of a group of users to whom a content request task to be send; and
a payment amount for submission of the requested digital media content.

16. The system of claim 15, further comprising: making an electronic payment to a user whose content was accepted by the content management server.

17. The system of claim 13, wherein a registered and active mobile device user is a user who created a user account on the content management server and launched a content management application on its mobile device.

18. The system of claim 13, wherein indentifying one or more registered and active mobile device users that match one or more parameters of the content request task includes:
displaying a geographic map showing locations of one or more registered and active mobile device user.

19. The system of claim 13, wherein identifying one or more registered and active mobile device users that match one or more parameters of the content request task includes:
selecting one or more mobile devices users whose geographic location matches the location for content acquisition parameter of the content request task.

20. The system of claim 13, wherein indentifying one or more registered and active mobile device users that match one or more parameters of the content request task comprises: for each identified mobile device user displaying one or more of: a personal information of the user, a rating of the user, statistics of submitted content by the user, a list of submitted content, information about mobile device of the user, and payment history of the user.

21. The system of claim 15, wherein receiving a video recording from a mobile device user includes:
determining a speed of network connection with the mobile device user using a content management application launched on the mobile device of the user; and
when the speed of the network connection is below a threshold, requesting the content management application to transmit to the content management server one or more key frames of the video recording that have the most content changes therein.

22. The system of claim 15, wherein receiving a digital media content from one or more mobile device users includes:
determining a speed of network connection with one of the identified mobile device user using a content management application launched on the mobile device of the user; and
when the speed of the network connection is below a threshold, requesting one or more other identified mobile device users to acquire the requested content and distributing transmission of the acquired digital media content among two or more mobile device users.

23. The system of claim 13, wherein processing the received digital media content includes:
generating, by the content management server, a graphical user interface (GUI) for display to the content moderator, the GUI comprising a grid of previews of the digital media contents received from the users, wherein a preview of a video recording includes auto-playing a plurality of preselected video frames of the video recording in the displayed GUI grid.

24. The system of claim 13, wherein media distribution platform includes one of a television station, a radio station, a cable network, a social networking website, a photo-sharing website, a video-sharing website, an online store, and an online auction.

25. A non-transitory computer readable medium storing computer executable instructions for management of digital media content, including instructions for:
generating a content request task comprising a plurality of parameters, including a content description and a location for content acquisition;
identifying one or more registered and active mobile device users that match one or more parameters of the content request task;
transmitting the content request task to one or more identified mobile device users that match one or more parameters of the content request task;
receiving the requested digital media content from one or more mobile device users;
processing the received digital media content for previewing, editing and moderating the content by a content moderator;
determining based on results of the moderation, whether to accept or reject the digital media content received from user; and
submitting accepted digital media content to one or more media distribution platforms.
